(19) United States
(12) Patent Application Publication
(10) Pub. No.: US 2023/0404108 A1
(43) Pub. Date: Dec. 21, 2023

(54) RAW MATERIAL FOR ANIMAL NUTRITION COMPRISING AN ORGANO-MINERAL COMPLEX CONTAINING DIETARY PHOSPHATE AND A HUMIC SUBSTANCE

(71) Applicant: AGRO INNOVATION INTERNATIONAL, SAINT MALO (FR)

(72) Inventors: Anca Lucia LAZA KNOERR, SAINT MALO (FR); Aurianne DE TONNAC, BRUZ (FR)

(21) Appl. No.: 18/035,224

(22) PCT Filed: Nov. 4, 2021
(86) PCT No.: PCT/FR2021/051946

§ 371 Date: May 3, 2023

(30) Foreign Application Priority Data
Nov. 4, 2020 (FR) 2011320

(51) Int. Cl. A23K 20/26; A23K 20/121; A23K 50/75; A23K 50/10; A23K 50/30

(52) U.S. Cl. CPC A23K 20/26; A23K 20/121; A23K 50/75; A23K 50/10; A23K 50/30

(57) ABSTRACT

The invention relates to a dietary raw material for animal nutrition, comprising an organo-mineral complex containing a dietary phosphate and a humic substance. The raw material improves the digestibility of the ration, absorbs mycotoxins and increases zootechnical performance.

### TECHNICAL FIELD

The invention relates to a novel raw material containing phosphate, intended for animal feed. This novel raw material combines dietary phosphate with an organic compound in the form of an organo-mineral complex, which increases the digestibility of inorganic phosphorus in the ration of livestock animals and has beneficial effects on some biological effectors.

### PRIOR ART

Phosphorus (P) is a chemical element that is indispensable to life on Earth. It plays indeed a role in the proper functioning of the metabolism of many organisms, fauna and flora, such as human beings, animals, micro-organisms or plants, by participating in the energy processes (production of adenosine triphosphate, ATP), in bone and dental synthesis, in the composition of deoxyribonucleic acid (ADN) and ribonucleic acid (ARN), in the composition of cell membranes (phospholipids, etc.) and in the regulation of blood acidity. Indeed, the worldwide use of mineral phosphates, a source of potassium, has multiplied by a factor of 15 since 1950 and the demand is expected to increase by 50 to 100% between now and 2050 due to the increase in the world's population. However, the sources of mineral potassium (phosphate rock) are not renewable and their stock is destined to disappear over time. It is therefore necessary to find alternative solutions or at least to increase the efficiency of the natural phosphate used.

Phosphorus (P) is therefore an indispensable element for the good health of animals and for livestock rearing productivity. It is necessary to add a mineral phosphorus intake to the feed ration of livestock animals in order to improve animal weight gain, milk production, bone mineralisation and fertility.

With regard to animal nutrition, in poultry and pigs, a global approach is often preferred, in which the need is defined as being the intake enabling performance and/or bone mineralisation to be maximised. However, in the case of monogastric animals, improving the digestibility of phosphorus in the ration may involve the use of more digestible sources of mineral phosphorus or consist of making phytic phosphorus (phytates) available in the ration. Indeed, since monogastric animals do not produce phytase, the enzyme necessary for hydrolysis of phytates, this major form of phosphorus in cereals and cakes is very poorly digested in these animals, as by humans. This involves the use of natural phytases contained in some cereals and co-products coming from their transformation for human food, and especially by the incorporation of phytases of microbial origin in the ration, which is currently a common practice in animal feed.

In contrast to monogastric animals, it has long been agreed that little effect is to be expected in ruminants from the use of microbial phytase, since rumen bacteria produce it naturally. Phosphorus is one of the minerals essential to ruminants and is involved in many metabolisms. Rumen bacteria have phosphorus requirements 2.0 to 2.5 times greater than the maintenance requirement of the animal. This requirement is partially met by food contributions but the contributions from recycling saliva provide a readily available form of phosphorus, the use of which is favoured by rumen microorganisms. Phosphorus plays an indispensable role in bacteria, in particular for their structure or for ATP synthesis.

Despite the importance of phosphorus in the rumen (saliva source), it is absorbed by the animal in the duodenum, jejunum and the large intestine. Phosphorus is used in the diet of a dairy herd for bone growth, energy metabolism and for the milk production of the animals.

A deficiency in dietary phosphorus can disturb milk production, feed consumption and the performance of the animal and cause a state of latent acidosis which despite dietary intake is not resolved until salivation is sufficiently reduced. The solubility of the source is not a determining factor for managing this disorder. In the case of a deficiency, the ruminants' system will draw on their phosphorus reserves, namely the phosphorus stored in the tissues or in the bones. This type of short-term deficiency at the start of lactation is not a problem if it is corrected quickly, before the onset of the 2^{nd} phase of lactation, as in the case of calcium (Ca) metabolism.

More precisely, the dietary requirements of the animal in lactation are important during the second phase of lactation because this is the moment when the animal reconstitutes its reserves. The absorption of phosphorus shows little interaction with other minerals, but the ratio Ca/P is important. It is normal between 1 and 8 (and up to 16) but an excess of Ca can increase the effects of phosphorus deficiency.

Conversely, if the intake is excessive compared with the requirement, phosphorus will eventually be found in the faeces. Research has therefore been carried out in order to determine the phosphorus requirements more precisely, with the aim of ensuring the health and productivity of cows, while reducing to a minimum the excretion of this nutrient in the faeces. Excess phosphorus is excreted in the faeces or urine when saliva recycling saturates, which corresponds to a concentration in the blood of 2.5-3 mmol/L.

Based on knowledge of the digestive and metabolic use of potassium, it is possible to determine the phosphorus balance in different livestock species, namely the quantities consumed, digested, absorbed, excreted or deposited in the tissues. However, the level of efficiency of phosphorus retention relative to ingestion, varies greatly between species. The highest efficiency is obtained in standard hens (62%), followed by pigs, red label hens and dairy cows (41, 38 and 29% respectively), laying hens and suckling cows having the lowest values (21 and 15% respectively).

In the course of digestion, the rise in pH in the digestive tract of monogastric animals causes the recomplexation of oppositely charged ionised molecules initially solubilised in the stomach. These molecular recomplexations, in particular between calcium ions and phosphate ions, reduces the absorption thereof in the organism. This recomplexation phenomenon therefore has the consequence of reducing the digestibility of nutrients and, in particular, of minerals. Moreover, the discharge of inorganic phosphorus that has not been absorbed by the animals into the environment represents an economic loss for the farmers, and could soon be limited in the context of respect for the environment.

Consequently, it is necessary to improve the bioavailability of inorganic phosphorus added to the ration of animals.

Overdosing calcium is also harmful for the quality of digestion. In order to limit the above-mentioned negative effects on the digestive tract and on the health of animals, it is therefore essential to limit its dose in the feed.

Furthermore, calcium has an inhibitory action on the activity of phytases. Manufacturers of feed for monogastric animals therefore have a tendency to overdose the phytases in order to obtain a better overall digestibility of the ration and therefore to maximise the zootechnical performance.

The raw material of the invention contains a dietary phosphate and a humic substance, such as a humic acid, a fulvic acid or humates.

Humic substances are commonly used for improving the digestibility of feed-rations. The prior art already describes feeds or dietary raw materials containing humic substances and calcium phosphate, such as patent application CN109198275 for example, which proposes a raw material for improving the nutritional balance of carp and promoting their growth. However, in this raw material, the calcium phosphate is not complexed with the humic substance, since they have not reacted together. The two compounds are simply dry mixed and ground, so that the complex cannot form. Furthermore, patent application CN109198275 does not address the problem of bioavailability of phosphorus in animals.

Consequently, the need remains to improve the zootechnical performance of livestock animals in order to increase, in particular, the digestibility of inorganic phosphorus present in the ration.

### GENERAL DESCRIPTION OF THE INVENTION

The invention solves these problems and responds to these needs by proposing a dietary raw material for animal nutrition, comprising an organo-mineral complex containing dietary phosphate and a humic substance, said humic substance forming physicochemical bonds with atoms, such as calcium atoms and/or the phosphorus atoms of the dietary phosphate.

Indeed, the inventors have surprisingly found that the humate-phosphate complex confers an improvement in the effects of the phosphate compared with results recorded when the latter is used alone. These effects concern, in particular, the zootechnical performance, the digestibility of the phosphorus in the ration and the regulation of certain biological effectors.

More specifically, the inventors have shown that the nutritional properties of phosphorus of mineral origin can be improved by complexing it with a humic substance.

Methods consisting of administering humic substances and phosphate separately, described in the prior art as dietary raw materials, and adding them dry to the ration without reacting them with one another beforehand, are not able to achieve these effects.

Without being bound by any theory, the inventors think that, in the case of calcium phosphate, the complexing of the calcium with the humic substance makes it at least partially unavailable in the digestive tract and thus allows an increase in both the efficiency of the digestion of phosphorus and the efficiency of phytase activity. The raw material of the invention thus makes it possible to reduce the necessary phosphate dose and/or the necessary phytase dose in the feeds.

The present invention stems from the surprising advantages determined by the inventors of the effect of complexing by humic substances of calcium ions and/or phosphates, on the bioavailability of phosphorus during digestion in a monogastric animal. The digestibility of inorganic phosphorus is improved by using a complex between mineral phosphorus and an organic molecule based on a humic substance, in particular humates or humic acids. This leads, in particular, to a better digestibility of the ration (and of phosphorus, in particular) for all species, a better bone mineralisation (for chickens and hens, for example, which reduces lameness in rearing and delays the culling of layers) and a better quality of eggshell (for hens) which reduces the rate of egg downgrading and increases the level of hatchability and viability of chicks. Beyond these nutritional benefits, the raw material of the invention also provides benefits for the farmers, since it enables a saving on ingredients and an increase in productivity. The fact of bonding calcium with a humic substance limits the many reactions of this cation with the other elements present in the alimentary canal. Indeed, these reactions are often sources of performance loss. The raw material of the invention therefore leads to a better efficiency of the ration, and thus reduces discharges of phosphorus into the environment.

More precisely, the dietary raw material can maintain zootechnical performance if it is incorporated in a dose that can reach 80% of the routine phosphorus requirements.

The raw material of the invention also combats mycotoxins, because it is capable of absorbing them at various pH values during digestion.

More precisely, in the digestive tract, the organo-mineral complex is capable of absorbing some of the aflatoxins and other mycotoxins initially present in the ration.

### DETAILED DESCRIPTION OF THE INVENTION

The dietary raw material for animal nutrition may comprise an organo-mineral complex based on a dietary phosphate and a humic substance, said humic substance being able to form physicochemical bonds with phosphorus atoms of the dietary phosphate. The organo-mineral complex can alternatively comprise a phosphate matrix in which the humic substance is dispersed, preferably with a content by weight ranging from 0.5% to 15%.

In a particular embodiment, the organo-mineral complex is a calcium phosphate matrix comprising 0.5% to 15% by weight, preferably 1.0 to 2.5% by weight humates, relative to the weight of calcium phosphate and humates.

In the organo-mineral complex, the humic substance can form chemical bonds with some or all of the phosphorus atoms of the dietary phosphate: the phosphorus can be complexed with the humic substance. The complexing of the phosphorus with the humic substance in the organo-mineral complex can be determined by any method known to a person skilled in the art, in particular by x-ray diffraction (XRD) or nuclear magnetic resonance of phosphorus 31 (³¹P NMR).

The dietary phosphate can be anhydrous or hydrated. It can be chosen from calcium phosphate, magnesium phosphate, monosodium phosphate (MSP), calcium-sodium phosphate and one of the mixtures thereof. In the raw material of the invention, the dietary phosphate can be chosen from monocalcium phosphate (MCP), dicalcium phosphate (DCP), monodicalcium phosphate (MDCP), tricalcium phosphate (TCP) and the mixtures thereof. The phosphate can also be in the form of tri-magnesium phosphate.

In a particular embodiment, the dietary phosphate contains or consists of calcium phosphate. The humic substance is preferably a humate.

When the dietary phosphate is a calcium phosphate for example, the molecules of the humic substance can form chemical bonds with the calcium atoms and/or with the phosphorus atoms contained in the calcium phosphate. The complexing of calcium atoms can be determined by the same methods as those used to detect the complexing of phosphorus.

The term physicochemical bond shall mean an ionic, hydrogen, Van der Walls or covalent bond.

The organo-mineral complex can be obtained from a source of calcium, a source of phosphorus and a humic substance. The humic substance can be complexed with calcium and/or with phosphorus.

The dietary phosphate of the raw material of the invention can further contain calcium phosphate, magnesium phosphate, sodium phosphate and/or a mixture of sodium and calcium phosphate.

In the particular embodiment of the invention according to which the dietary phosphate contains calcium phosphate, the humic substance firstly acts by complexing with calcium cations. The advantage of the complexing is, in particular, to increase the bioavailability of phosphorus by making calcium unavailable. Secondly, the humic substance participates in the metabolic reactions taking place in the digestive tract, while remaining at least partially complexed with the calcium after passage in the stomach. The free fraction of the humic substance has a possibility of itself complexing with the other cations present in the alimentary canal, in particular, the free ionised calcium.

The dietary phosphate may contain or consist of sodium phosphate, calcium-sodium phosphate or magnesium phosphate, and the humic substance can form chemical bonds between the molecules that it contains and the sodium or magnesium atoms respectively.

Within the context of the present invention, “humic substance” shall mean a molecule or a set of molecules of natural origin which comply with the definition of the International Humic Substance Society (IHSS), according to which humic substances are complex heterogeneous mixtures of polydispersed materials formed in soils, sediments and natural waters, by biochemical and chemical reactions, during a decomposition and transformation process of plant and microbial residues, which process is named humification. Many compounds participate in the humification, such as plant lignin and its transformation products, polysaccharides, melanin, cutin, proteins, lipids, nucleic acids and the residues of carbonisation.

The main molecules present in the humic substances include dark brown or grey-black humic acids (HA), light yellow or brownish-yellow fulvic acids (FA) and black humin. The closer the colour of the humic substance gets to black, the more the molecular weight of the molecules that it contains increases, the more the carbon content increases, the more the oxygen content decreases and the more the acidity exchange decreases.

The humic substance which enters the composition of the organo-mineral complex can comprise at least one molecule chosen from humic acids and fulvic acids.

The humic substance can be, in particular, chosen from water-soluble humic substances having carboxylate and phenolate functions that are referred to as humates in the present description. These include sodium humates and potassium humates.

According to an embodiment of the invention, the humic substance is chosen from the sodium humates, having a higher ion exchange capacity, the sodium ion being more easily exchangeable in the digestive tract of the animal, in comparison with a divalent calcium or potassium ion.

The humic substance can be prepared by treating humic substances that are naturally in acid form, with an appropriate quantity of a strong base, such as sodium hydroxide or potassium hydroxide, in order to obtain humates. For example, the starting product in the form of humic acids naturally present in a soil could be used to produce humates. The humates could be procured in the form of an aqueous solution, or in dry form which can then be dissolved in water.

An aqueous dispersion of humic substances can comprise a non-negligible quantity of insoluble matter. This is the case, for example, when the liquid composition of humic substances is prepared from a raw material mixed with water. In this particular case, the soluble fraction can be isolated by separating it from the insoluble fraction, for example by decanting, filtering or centrifuging.

The humic substance can be obtained from natural humic substances. It can, for example, be a raw material containing humic substances, for example peat, leonardite, lignite, bituminous coal or anthracite. Thus, the humic substance can be a liquid composition of peat, leonardite, lignite, bituminous coal or anthracite. In a particular embodiment of the invention, the humic substance is extracted from leonardite.

Peat is an organic fossil material formed by accumulation, over long periods of time, of dead organic matter, essentially plants, in a water saturated environment. Peat forms the major part of peatland soils. Peat can be more or less rich in humic substances according to the degree of decomposition. The degree of decomposition of peat is classified according to the Von Post scale which runs from H1 (the least decomposed peat) to H10 (the most decomposed peat). Humus peat, in other words peat classified from H6 to H10 according to the Von Post scale, is the preferred peat for implementing the method according to the invention, because it is richer in humic substances than peat classified from H1 to H5 according to the Von Post scale.

Leonardite is a rock which contains more than 90% by weight humic substances. The rock has undergone a more powerful degradation than peat, but less powerful than for bituminous coal.

Lignite is a sedimentary rock composed of fossil remains of plants. This is an intermediary rock between peat and bituminous coal.

Bituminous coal is a sedimentary carbonaceous rock corresponding to a specific quality of carbon, intermediate between lignite and anthracite. Blackish in colour, it comes from the carbonisation of plant organisms.

Anthracite is a sedimentary rock of organic origin. It is a grey, blackish and glossy variety of coal, extracted from mines.

The humic substance can also be obtained from synthetic humic substances. Synthetic humic substances can result, for example, from a synthesis or from a transformation process of natural humic substances, in particular, by semisynthesis

The humic substance can also be extracted from organic matter (peat, leonardite, lignite, bituminous coal, anthracite, soils rich in humic substances, composts of plant waste, etc.) using an alkaline agent such as sodium hydroxide (NaOH) or potassium hydroxide (KOH) and optionally undergoing purification. The humic substances can, in particular, be extracted and/or purified by methods that are well-known to a person skilled in the art. The humic substance can be a potassium humate or, preferably, a sodium humate.

The humic substance encompasses liquid compositions of a salt of humic substances. The preferred salts include, in particular, ammonium salts, sodium salts and potassium salts. Preferably, a sodium salt of humic substances is used, such as sodium humates or the sodium salt of humic substances, due to its high capacity for ionic exchange. Salts of humic substances are sold commercially. They include, for example, the potassium salt of humic substances marketed by Humatex under the tradename Dralig® (CAS 68514-28-3). The product Dralig® is prepared from humic substances extracted from natural Czech oxyhumolite with a high content of humic substances. Sodium humate (CAS Number 68131-04-4) can also be mentioned and is commercially available under the name Nut Mordan® manufactured by Humatex. A person skilled in the art would have no difficulty preparing a salt of humic substances.

The purity of humic molecules of the humic substance can also vary, for example according to the sources used. Of course, peat is generally less pure in humic substances than leonardite or than a commercial powder of humic substances. In a particular embodiment, the humic substance comprises at least 50% by weight dry humic molecules.

The present application also describes a dietary raw material which comprises calcium phosphate and a humic substance. The calcium phosphate can be a monocalcium phosphate or a dicalcium phosphate. The level of humic substance can vary from 0.5% to 10% by weight, preferably 1.0% to 2.5%, and more preferably from 1.25% to 1.75% by weight, relative to the weight of the raw material, and the raw material can comprise 90% to 99.5% by weight calcium phosphate.

The invention also relates to a method for producing the dietary raw material described above, said method comprising a step of preparing an aqueous dispersion or an aqueous solution containing the humic substance, followed by a step of mixing this dispersion or this solution with a source of phosphorus. In a particular embodiment, the production method comprises a step of mixing the humic substance with a source of calcium, magnesium or sodium.

The complexing of the humic substance with phosphorus atoms, and optionally with atoms of calcium, magnesium or sodium, and the creation of chemical bonds between the humic substance and the phosphorus atoms can be obtained through the presence of the humic substance in a reaction mixture containing the source of phosphorus and the source of calcium, magnesium or sodium. Chemical bonds can be created by insertion of the humic substance at the time of the reaction between a source of phosphorus and a source of calcium, magnesium or sodium. In a particular embodiment, the chemical bonds of the organo-mineral complex are created by insertion of humates at the time of the reaction between a source of phosphorus and a source of calcium.

The dietary raw material described above can be obtained by preparing an aqueous dispersion or an aqueous solution containing a humic substance, a source of phosphorus, and optionally a source of calcium, magnesium or sodium. For example, the dietary raw material of the invention is obtained by preparing an aqueous dispersion or an aqueous solution containing the humic substance, followed by mixing of this dispersion or this solution with the source of phosphorus and with the source of calcium, magnesium or sodium.

The aqueous dispersion or aqueous solution of humic substance preferably has a basic pH, for example a pH ranging from 8.0 to 12.0, from 8.0 to 11.0 or from 10.0 to 12.0. Phosphoric acid can be brought into contact with a humic substance in aqueous solution having a pH ranging from 10.0 to 12.0, for example ranging from 10.5 to 11.5 within measurement uncertainties.

According to a particular embodiment, the dietary raw material of the invention can be obtained by a preparation method comprising a step of mixing a source of phosphorus, for example phosphoric acid, a source of calcium, for example calcium oxide or hydroxide, and a humic substance in solution or in dispersion in water, having a pH ranging from 8.0 to 12.0, for example a solution of humic substance. A solution of humic substance which can advantageously be used is a humate solution having a pH ranging from 10.0 to 12.0, for example a sodium humate solution. It is preferred to use a water-soluble humic substance for preparing the dietary raw material of the invention. It is preferred to use a water-soluble source of phosphorus, such as phosphoric acid, diluted in water or not diluted in water. The mixing of the solution of humic substance and the source of water-soluble phosphorus is preferably carried out at one temperature.

The mixing of the aqueous dispersion or of the aqueous solution containing the humic substance with the source of phosphorus, and optionally with the source comprising calcium, magnesium or sodium, can be carried out at a temperature ranging from 40° C. to 80° C., from 45° C. to 80° C., from 50° C. to 80° C., or preferably from 60° C. to 80° C. The temperature can range from 45° C. to 55° C.

A method for producing the dietary raw material can comprise a step of purification, extraction or treatment of a humic substance sampled in the natural state in order to obtain humates which can then be dissolved in water.

In a particular embodiment, the humic substance dissolved in water is mixed with a source of phosphorus and a source of calcium. The weight ratio between the source of phosphorus and the source of calcium is preferably chosen so as to produce a compound of dietary phosphate chosen from the group consisting of monocalcium phosphate (MCP), dicalcium phosphate (DCP), monodicalcium phosphate (MDCP), tricalcium phosphate (TCP) or one of the mixtures thereof, the matrix of the dietary phosphate comprising a humic substance, preferably humates with a content ranging from 0.5% to 15% by weight relative to the dietary phosphate compound. For example, phosphoric acid with 54% P₂O₅ and calcium carbonate in a weight ratio ranging from 1.1 to 1.2, preferably equal to approximately 1.3 are chosen for producing dicalcium phosphate (DCP), the matrix of which contains a humic substance. Another example consists of choosing phosphoric acid with 54% P₂O₅ and calcium carbonate in a weight ratio ranging from 2.4 to 2.6, preferably equal to approximately 2.5, for producing a monocalcium phosphate (MCP), the matrix of which contains a humic substance. In these two examples, the concentration of an aqueous solution of humates can be chosen so as to obtain a dietary calcium phosphate compound comprising 1.0% to 2.5% by weight of humic substance relative to the weight of said compound. In a first embodiment, a solution of humic substance and a solution of phosphoric acid are prepared, the solution of humic substance is poured into the phosphoric acid solution, then calcium oxide is added to this mixture, each of these steps preferably being carried out at a temperature ranging from 40° C. to 60° C. and under stirring. In the second embodiment, the phosphoric acid that is not diluted with water, and a solution of humic substance is poured onto calcium oxide, calcium hydroxide or the calcium carbonate.

The source of calcium which can be used to prepare the raw material of the invention can be calcium carbonate (CaCO₃) or quicklime (CaO) or even slaked lime (Ca(OH)₂). The source of phosphorus can be phosphoric acid. The source of calcium, magnesium or sodium, and phosphoric acid react with the humic substance placed in solution or in aqueous dispersion.

The raw material of the present invention can be manufactured by various methods according to the manner in which the humic substance is mixed with the source of calcium, magnesium or sodium, and with the source of phosphorus. For example, the humic substance can be introduced simultaneously but separately from the other raw materials, introduced in a premix with the source of calcium, magnesium or sodium, mixed with the source of phosphorus before dissolving in water, be introduced in the source of phosphorus once having been dissolved in water, or introduced into water.

According to a particular embodiment, the humic substance is a humate mixture which is dissolved in water in order to obtain an aqueous solution of humates, which solution is then mixed, under stirring, with phosphoric acid. The dispersion obtained can be mixed with calcium carbonate. The P₂O₅ titre of phosphoric acid can range from 52% to 60%. The concentration of humates in the aqueous solution of humates can range from 50 g/L to 250 g/L of water. In the aqueous dispersion containing humates and phosphoric acid, the phosphoric acid is preferably diluted between 40% and 55% P₂O₅.

The humic substance represents, for example, between 0.1% by weight and 10% by weight of the weight of a mixture consisting of i) a source of calcium, magnesium or sodium, ii) the source of phosphorus and iii) the humic substance. When the humic substance is based on humates, the dose of humates in the raw material of the invention can comprise between 1.0% and 10.0%, preferably between 1.0% and 5.0%, more preferably between 1.0% and 3.0% by weight, and still more preferably between 1.0% and 2.5%, for example equal to 1.5% by weight, of the weight of said mixture.

The method according to the invention may include one on more additional steps, for example one or more steps of granulation or drying.

The present application describes a raw material intended for animal feed that can be obtained by preparing a mixture essentially consisting of water, a humic substance, a source of mineral phosphorus and, optionally, a source of mineral calcium.

The term “essentially consisting of” shall mean a mixture that comprises more than 95% by weight, preferably more than 98% by weight, and preferably still more than 99% by weight, and more particularly more than 99.5% by weight, water, humic substance, a source of phosphorus and a source of calcium. For example, the dietary raw material can be obtained, or is obtained, by preparing a mixture substantially consisting of water, humate, phosphoric acid and optionally calcium carbonate. The mixture can be obtained from an aqueous dispersion or an aqueous solution consisting of water and a humic substance, that are reacted with a source of phosphorus, and optionally with a source of calcium. The humic substance is preferably a humic acid or a humate, preferably a sodium humate. The source of phosphorus is preferably phosphoric acid. The source of calcium is preferably calcium carbonate, calcium oxide or calcium hydroxide.

The present application also describes a feed additive for animal nutrition, an animal feed comprising calcium humate and a source of phosphorus, for example a phosphate. Each of the features described above with respect to the feed of the invention and the method for preparing this feed can apply independently of one another to this feed additive and to this animal feed.

Another object of the invention relates to the use of a raw material as described above, in order to improve the bioavailability of mineral phosphorus in monogastric livestock animals. The invention is a means for intake of minerals and inorganic phosphorus, in particular, for monogastric animals, but also for ruminants.

The invention also relates to a method for nutrition of a livestock animal comprising a step of incorporating, in the ration of the animal, the raw material described above, this raw material optionally coming from a prior production in accordance with the method described above.

The invention also relates to a method for producing a premix or a complete feed for a livestock animal. The raw material of the invention is intended to be used in premixes or complete feeds intended for premixers or food producers for livestock animals.

The raw material can be used for poultry (standard or label meat chickens, laying hens, turkeys, guinea fowl, ducks and others), but also for pigs, cattle, sheep, goats, rabbits and aquaculture.

### DESCRIPTION OF THE FIGURES

FIG. 1 shows the x-ray diffraction diagram for a reference product containing monocalcium phosphate, devoid of humic substance (MCPH0).

FIG. 2 shows the x-ray diffraction diagram for a product of the invention containing 1.5% humates (MCPH15).

FIG. 3 compares the two diffraction diagrams of preceding FIGS. 1 and 2.

FIG. 4 shows the ³¹P NMR spectra of a reference product containing monocalcium phosphate devoid of humic substance (MCPH0), and that of the product of the invention containing 1.5% humates (MCPH15).

FIG. 5 shows the ³¹P NMR spectrum of a reference product containing monocalcium phosphate devoid of humic substance (MCPH0).

FIG. 6 shows the ³¹P NMR spectrum of the product of the invention containing 1.5% humates (MCPH15).

FIG. 7 shows the effect of the invention on the change in the pH of the ruminal medium from 2.0 to 6.5 hours incubation under in vitro fermentation conditions.

FIG. 8 shows the effect of the invention on the concentrations of VFA of the ruminal medium from 2.0 to 6.5 hours incubation under in vitro fermentation conditions.

FIG. 9 shows the effect of different doses of the invention on the rate of absorption of various mycotoxins in the stomach of monogastric animals under in vitro conditions.

FIG. 10 shows the effect of different doses of the invention on the rate of absorption of various mycotoxins in the intestine of monogastric animals under in vitro conditions.

FIG. 11 shows the average consumption index (CI) at the end of finishing (CIO-35 between D0 and D35) for batches of chickens for which the feed has been enriched with different MCP containing or not containing different doses of humates.

FIG. 12 shows the ash content and the quantity of calcium and phosphorus of the tibias of chickens taken at D35 as a function of the treatments.

FIG. 13 shows the breaking force of the tibias of chickens taken at D35 as a function of the treatments.

FIG. 14 shows, for each treatment, the deviation (%) in pH of chicken meat between the measured value and the expected value after 15 minutes maturation (pH=6.4) or 7 days storage (pH=5.6).

FIG. 15 shows the mean consumption index (CI) at the end of finishing (CIO-35 between D0 and D35) for batches of chickens for which the feed has been enriched with a standard calcium phosphate or the product of the invention MCPH15.

FIG. 16 shows the quantity of P₂O₅ in the litter on D42 of chickens having received, in their feed, a standard calcium phosphate or the product of the invention MCPH15.

### Example 1: Preparation of a Complex of Humates and Calcium Phosphate and Then Characterisation

### Preparation of the Complex

Several aqueous solutions of sodium humates with variable concentration of humates ranging from 100 g/L to 250 g/L are prepared by dissolving sodium humates in water, preferably water heated to 50° C.
Sodium humate (CAS Number 68131-04-4) is commercially available under the reference Nut Mordan® manufactured by Humatex. The pH of this product diluted to 10% in water is between 10.0 and 12.0 and its content of humic acid by dry weight is greater than 60%. The humic acid content by dr y weight is equal to the complement to 100% of the ash content measured after calcination of the sample in an electric furnace at 500° C. for 60 minutes and at 805° C.-825° C. for 60 minutes (according to the manufacturer).
A solution of Israeli green phosphoric acid (P₂O₅ total=54.2%) diluted to 50% P₂O₅ with water heated to 50° C. is prepared.
Each aqueous solution of humates is then poured, under stirring, into the solution of phosphoric acid, the stirring being maintained in order to disperse the solid formed and the temperature maintained at 50° C. Calcium carbonate (having a total CaO content greater than or equal to 53%) is then poured into the dispersion, then the mixture is stirred vigorously, crumbled, granulated and then dried.
Alternatively, the phosphoric acid is not diluted in water and it is poured simultaneously with the solution of sodium humates onto the calcium carbonate.
The weight ratio between the undiluted phosphoric acid at 54% P₂O₅ in water and the calcium carbonate was 2.5 for producing the MCP.
By varying the concentration of the solution of humates, monocalcium phosphates containing 1.0% (denoted MCPH10), 1.5% (denoted MCPH15), 2.0% (denoted MCPH20), 2.5% (denoted MCPH25), 5.0% (denoted MCP50) and 10.0% (denoted MCP100) of humates could be prepared.
Dicalcium phosphates containing 0% (denoted DCP), 1.0% (denoted DCP10), 5.0% (denoted DCP50) and 10.0% (denoted DCP100) of humates by applying a weight ratio [phosphoric acid at 54%P₂O₅/calcium carbonate]=1.3 could also be prepared. In the majority of tests, and in order to limit the number of invention samples studied, the choice was made for doses between 1.0% and 2.5%, preferably 1.5%.

### Characterisation by XRD and NMR

### Experimental Conditions of the XRD Analysis

The diffraction diagrams were recorded on a diffractometer (X'Pert Pro from PANalytical) in reflection mode and equipped with a copper tube (Kα=0.1542 nm, 45 kV and 40 mA) and a PIXcel linear detector (active length=3.347°2θ). On the x-ray beam path, 0.04 rad Soller slits, a 1/16° divergence slit, a 10 mm mask and a ⅛° anti-scatter slit were mounted as primary optics, and a nickel filter and 0.04 rad Soller slits as secondary optics. After fine grinding, the samples were compacted in a rear-loading sample holder.

### Results of the XRD Analysis

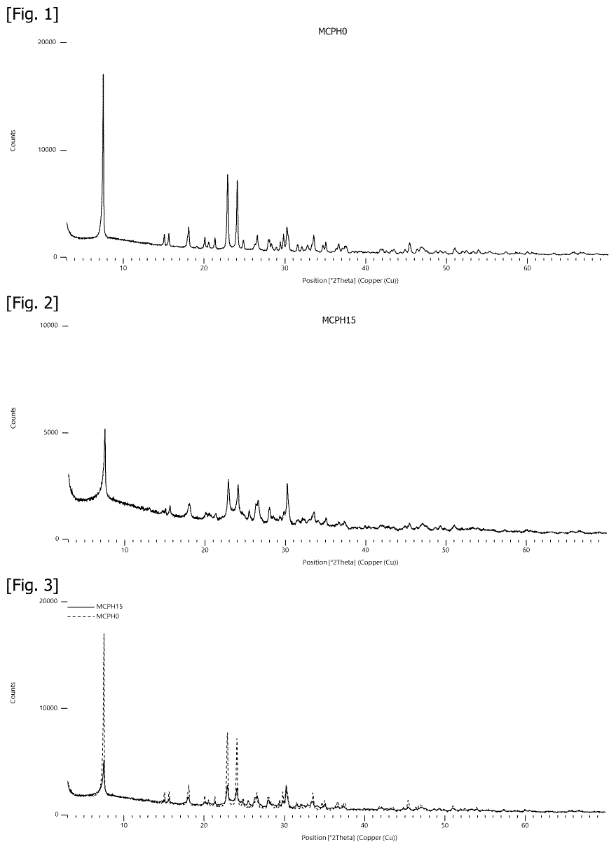

The peaks of the diffraction diagram showed that the MCP without humate (MCPH0) consisted of two crystalline phases: in the majority monohydrated monocalcium phosphate (Ca(H₂PO₄)₂,H₂O) and as a minority calcite (calcium carbonate; CaCO₃). However, three very low intensity peaks could be identified after 65°, the reflections of the reference card only having been recorded up to 64° (FIG. 1). This indicates that an additional crystalline phase is present in the MCPH0 without being identifiable by XRD.
The peaks of the diffraction diagram for MCPH15 show that this sample contains mainly monohydrated monocalcium phosphate (Ca(H₂PO₄)₂,H₂O), probably anhydrous dicalcium phosphate (monetite Ca(HPO₄)) and possibly calcite (calcium carbonate; CaCO₃) and anhydrous monocalcium phosphate (Ca(H₂PO₄)₂ (FIG. 2). However, the diffraction diagram of MCPH15 shows diffraction peaks that are less intense than that of MCPH0, which indicates that this sample is less well crystallised. In order to confirm this, when the two diffraction diagrams of the two samples are superimposed, it can be observed that the baseline of the MCPH15 sample, between 15 and 40°, is higher than that of the MCPH0 sample (FIG. 3). This thus indicates the amorphous presence in the MCPH15 sample. In addition, the organic matrices cannot be identified by x-ray diffraction and thus appeared as an amorphous phase. This drop in intensity of the peaks and this higher baseline of MCPH15 are explained by the presence of humates which correspond to a non-crystalline organic product and an amorphous phase that is not identified by XRD. In general, the organo-mineral complexes characterised by XRD show a broadening of the curves which indicates the presence of an amorphous product in the sample.

### Experimental Conditions for the NMR Analysis

After fine grinding, the samples (powders) were introduced (packed) into a cylindrical sample holder (rotor) made of zirconium oxide, 4 mm in diameter and closed by a Kelefl® plug. The analyses were carried out at room temperature using a Bruker Avance II 400 MHz spectrometer (Larmor frequency (³¹P)=103.85 MHz), equipped with a Bruker 4 mm double channel measurement head. The ³¹P MAS (Magic Angle Spinning) spectra were recorded at a rotation speed of 12 kHz with a pulse angle equal to a duration of 3 microseconds and a recycling time of 200 seconds. The chemical shifts are expressed relative to an aqueous solution at 85% H₃PO₄. After analysis, the samples were fully recovered.

### Results of the NMR Analysis

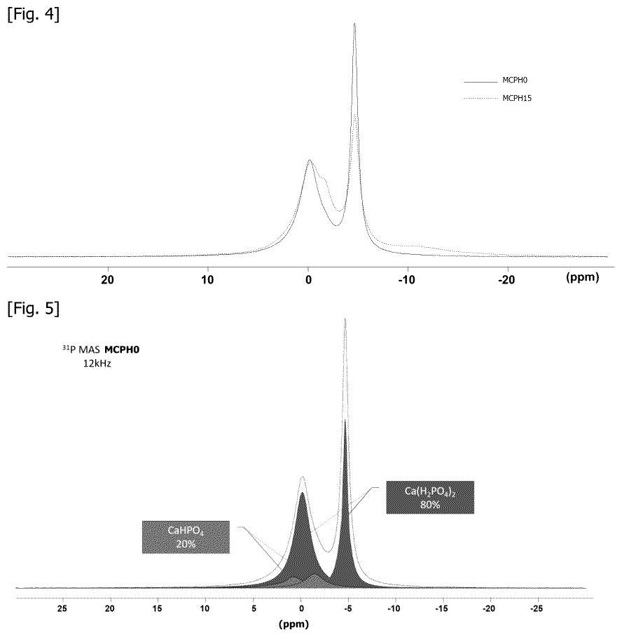

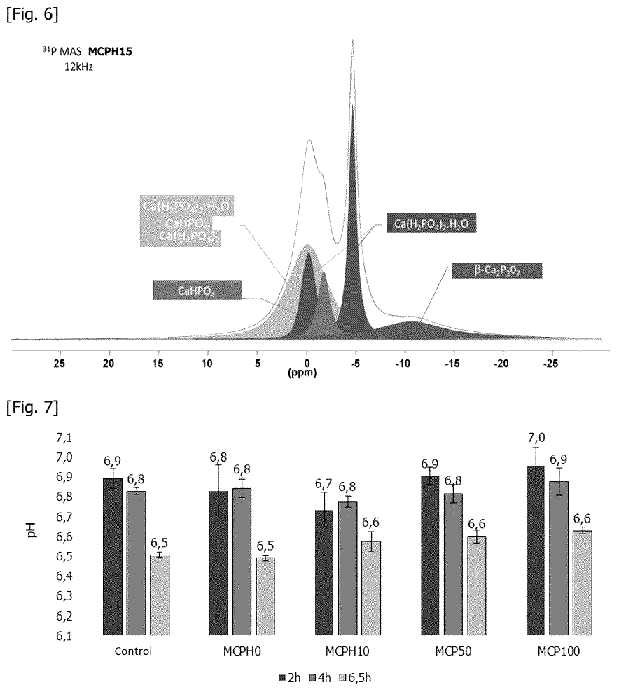

FIG. 4 shows the superposition of the ³¹P NMR spectra for the two samples analysed. More precisely, FIG. 5 shows that after deconvolution, the spectrum for MCPH0 has four signals at 0.75, −0.15, −1.45 and −4.65 ppm. The signals at −0.15 and −4.65 correspond to the presence of monohydrated monocalcium phosphate (Ca(H₂PO₄)₂,H₂O) as majority compound (80%), as demonstrated by the XRD analysis. In addition, these two signals correspond to two H₂PO₄⁻groups which are differentiated, with the group at −4.65 being an acceptor of hydrogen bonds with the protons of the water molecule, whereas that at −0.15 would be a hydrogen bond donor. The two largest signals at −1.45 and 0.75 ppm characterise the crystallographic sites of the dicalcium phosphate (CaHPO₄) not revealed by XRD and being the minority quantity in this sample (20%).
FIG. 6 shows that, after deconvolution, the spectrum for MCPH15 has five signals at −0.1, −0.2, −1.75, −4.75 and −10.0 ppm. As in the MCPH0 sample, the characteristic signals of monohydrated monocalcium phosphate (Ca(H₂PO₄)₂,H₂O) are observed at −0.2 and −4.75 ppm, but in lower proportion (40% of the sample), their corresponding peaks being lower than for MCPH0. The peak at −1.75 ppm corresponds to the peak at −1.45 ppm of MCPH0, it therefore involves the presence of dicalcium phosphate (CaHPO₄), at a level of 10%. However, for MCPH15, it is impossible to distinguish the equivalent of the peak at 0.75 ppm for MCPH0, which also reveals the presence of this dicalcium phosphate. Thus, the particularly broad signal at −0.1 ppm would correspond to the superposition of several chemical elements, namely; the missing portion of monohydrated monocalcium phosphate

(Ca(H2PO4)2,H2O; i.e. 20%), the invisible resonance of this dicalcium phosphate (CaHPO₄; i.e. 10%) and a hidden portion of anhydrous monocalcium phosphate (Ca(H₂PO₄); at a height of 5% to 10%) the only phosphate component, for which the chemical shifts are in the region around −0.1 ppm. Although in a very low quantity, this last compound can only be present in amorphous form, explaining the characteristic shape of the very broadened signal. Finally, the very broad signal between −6.0 and −12.0 ppm corresponds to amorphous β-Ca₂P₂O₇ pyrophosphates, present at around 15% in the sample. This amorphous characteristic is determined by the width of the signal which indicates that the environment of the phosphorus is very disordered and therefore modified. This peak reflects the new environment of the phosphate bonded by the Ca-humic acid bond sites, highlighting the complexing of humic acids with minerals (Ca or P). The broadening of these two peaks, which reveal amorphous phases, determines a chemical reaction between the sources of phosphorus and the humates indicating the presence of complexes.

Thus, the results of the analyses by XRD and ³¹P NMR of the two samples are consistent and complementary. With regard to the MCPH0 sample, the two methods confirm the presence of crystallised monohydrated monocalcium phosphate

(Ca(H₂PO₄)₂,H₂O). Contrary to the XRD, the ³¹P NMR determines the presence of dicalcium phosphate, otherwise referred to as monetite (CaHPO₄), in the MCPH0 and presumably in amorphous form (broad NMR signals at −1.45 and 0.75 ppm) because it was not detected by XRD. This means that the 3 unidentified peaks beyond 64° do not correspond to this monetite. On the other hand, XRD reveals that crystallised calcite (CaCO₃) remains in MCPH0. Finally, ³¹P NMR makes it possible to estimate that the relative proportions of phosphorus are distributed in the following manner: as majority phase 80% as Ca(H₂PO₄)₂,H₂O and approximately 20% as CaHPO₄.

With regard to the MCPH15 sample, the ³¹P NMR can confirm the presence of crystallised phases observed by XRD, namely: monohydrated monocalcium phosphate (Ca(H₂PO₄)₂,H₂O) which is in the majority, followed by monetite (CaHPO₄). Amorphous or very slightly crystallised (because visible by XRD) anhydrous monocalcium phosphate (Ca(H₂PO₄)₂) is also present. The ³¹P NMR also determines the presence of a new species, (β-Ca₂P₂O₇) calcium pyrophosphates, which are in amorphous form since they are not identified by XRD. According to the XRD, residual traces of calcite also appear to be present. Other types of amorphous phases have been identified. Some amorphous phases, which are not perfectly identified by NMR, are linked to the presence of complexes in the sample, which determines that a chemical reaction has taken place between the sources of phosphorus and the humates. Physicochemical bonds between the humate type organic matrix and the minerals are present in the system (calcium and phosphorus). Finally, ³¹P NMR can evaluate, in a very relative manner, the distribution of phosphorus in the following way: majority phase, more than 50% Ca(H₂PO₄)₂,H₂O, several minority phases (less than 50%) have been identified for CaHPO₄, amorphous pyrophosphates and partially crystallised Ca(H₂PO₄)₂, also an amorphous phase represented by the broadening of the spectra (curves) corresponding to the applicant's organo-mineral complex.
Thus, the two analyses, XRD and NMR, reveal the presence of amorphous phases equivalent to an organo-mineral complex originating from chemical reactions in the medium between humic acids and inorganic compounds (calcium phosphates).

### Example 2: In Vitro Test on an Artificial Fermenter: Impact of the Product of the Invention on the Fermentation Parameters

A test has been carried out in an artificial fermenter with four products of the invention MCPH0, MCPH10, MCPH5 and MCPH100 prepared according to Example 1.

### Experimental Protocol

The principle of artificial fermentation relies on the incubation of rumen fluid under anaerobic conditions at 39° C. (Menke and Steingass, 1988). The bacterial flora in the presence of the appropriate substrate reproduces the ruminal fermentations, which enables the gas production to be monitored as well as the end products such as volatile fatty acids (VFA), N—NH₃ etc. according to the objectives of the study.

The device consists of 21×250 ml flasks containing 150 ml of an inoculum based on rumen fluid and buffered artificial saliva (1:2). This inoculum is incubated under anaerobic conditions at 39° C. without substrate (blank) or with 1.25 g of substrate (corn silage, hay, concentrate: 50/30/20, provides 2.2 g of P/kg) alone (CT control) or with the substrate supplemented with the appropriate dose of each product tested, in order to have an identical phosphorus intake (MCPH0 to MCPH100). The flask sampling system makes it possible to carry out kinetics at 2 hours, 4 hours and 6 hours 30 minutes. Table 1 reports the experimental design of the test.

TABLE 1
Experimental design of the in vitro fermentation
test in the presence of products of the invention

| | | Concentration | Product dose | Number |
|---|---|---|---|---|
| Product | Substrate | P(%) | (g/D/VL) | of flasks |
| CT | EM/F/C | — | — | 4 |
| MCPH0 | 50/30/20 | 22.4 | 100 | 4 |
| MCPH10 | | 22.5 | 99.6 | 4 |
| MCPH5 | | 21.9 | 102.3 | 4 |
| MCPH100 | | 21.7 | 103.2 | 4 |
| Blank | — | — | — | 1 |
| | | | Total | 21 |

### Results

FIG. 7 shows the change in pH at the start and end of fermentation. The treatments and the time have a significant effect (p.val<0.001). The high dose (10%) of humic acid in MCP increases the pH relative to the control and the other treatments. Moreover, the “treatment*time” interaction is significant (p.val=0.06). It therefore appears that the impact of the treatments varies according to the kinetic points.

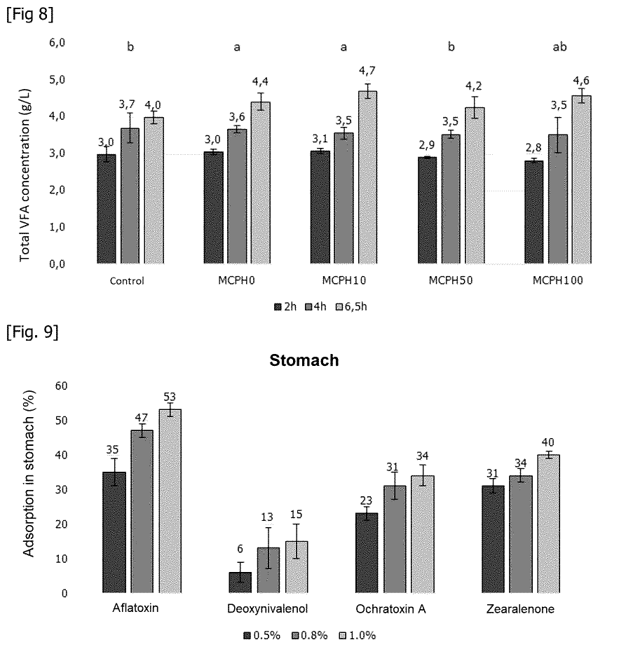

FIG. 8 shows that the concentrations of VFA increase over time (p.val<0.001). Some treatments in particular tend to increase the total production of VFA relative to the CT control (p.val<0.10). The statistical study of this parameter shows a significant interaction between the treatments and the times (p.val=0.02). The results of the statistical study at each time show that after 2 hours fermentation, the high doses of humic acids tend to reduce production of VFA (p.val=0.07). After 4 hours, the treatments have no effect (p.val>0.10). Finally, after 6 hours, the addition of MCP increases the production of VFA and the formulas with 1% and 10% humic acids promote this effect (p.val<0.01).

### CONCLUSION

This in vitro study has evaluated the effects of MCP-humate complex on fermentations of the rumen. The addition of MCP-humates complex limits the drop in pH during fermentation under these closed batch conditions. Moreover, it improves the production of VFA and therefore the energy intake for the ruminant.

### Example 3: Monogastric Digestion Test In Vitro: Impact of the Product of the Invention on the Digestibility of Minerals Ca, P and Mg

The objective of this in vitro digestion test is to evaluate the digestibility of the minerals Ca, P and Mg for the products of the invention from Example 1. In order to confirm the results, the test was repeated once. The results of the two in vitro test performed are thus presented: test 1 and test 2 below.

### Experimental Protocol

The device used is a bain-marie consisting of 15 places that can each receive a 50-ml Eppendorf tube each containing a feed sample of 1.0 g. The samples are incubated at 40° C. A test takes place in 3 steps in order to mimic the digestion of growing chickens, in the crop (amylase, pH: 5.8, duration: 35 min), then the succenturiate ventricle (pepsin, pH: 2.7, duration: 42 min) and finally in the intestine up to the ileal phase (pancreatin, pH: 6.5, duration: 170 min).

The bain-marie can accommodate 15 samples, a test is carried out over 1 day in order to have a sufficient number of repetitions per feed (n=3). From the 15 tubes, one tube is used to check the absence of contamination by minerals (blank, no sample) and one tube is used to receive wheat bran (laboratory standard) in order to check the proper proceeding of the test. Nine tubes are used to receive the samples of complete feed for growing chickens, which contain the products of the invention with the following doses of humates: 0% and 1.5%.

The chemical composition of the feeds to be digested is given in Table 2.

TABLE 2
Nutritional composition of two experimental
feeds for growing chickens.

| % | MCPH0 feed | MCPH15 feed |
|---|---|---|
| Humidity | 17.5 | 11.0 |
| MS | 82.5 | 89.0 |
| MM | 6.0 | 5.7 |
| MO | 94.0 | 94.3 |
| Proteins | 18.8 | 18.8 |
| Ca | 0.84 | 0.78 |
| P | 0.49 | 0.48 |
| Mg | 0.17 | 0.16 |
| Na | 0.17 | 0.16 |
| Ca/P | 1.71 | 1.63 |

The digestibility in vitro is expressed by calculating the solubility of the minerals. In other words, the greater the quantity of minerals in the food bolus fluid (ileal fluid) the greater the absorption potential of these minerals. The solubility is calculated as: Solubility (%)=quantity of mineral in the ileal fluid/quantity of mineral in 1 g of feed to be digested.

### Results

An in vitro digestion test has been carried out, in which MCPH0 and MCPH15 were compared. The results were as follows.

The solubility of the chicken feeds provided with MCPH0 or MCPH15 produced according to Example 1 is given in Table 3.

TABLE 3
Solubility of the minerals from the monogastric in vitro
digestion test as a function of the treatments based on
not based on the product of the invention (Avr ± S.D.).

| | | Ca solubility | P solubility | Mg solubility |
|---|---|---|---|---|
| Feed | n | (%) | (%) | (%) |
| MCPH0 | 2 | 59.6 (±0.74) | 68.2 (±3.15) | 57.8 (±2.99) |
| MCPH15 | 3 | 62.9 (±0.91) | 72.2 (±0.92) | 62.2 (±0.69) |
| p.val | — | 0.02 | 0.11 | 0.08 |

The solubility of calcium is significantly affected by the presence of humates (p.val=0.02). In addition, the solubility of calcium is significantly higher by 3 points in the presence of 1.5% humates than in its absence. Similarly, the solubility of phosphorus is not-significantly higher (p.val=0.11) by 4 points in the presence of humates than in its absence. Finally, the solubility of magnesium is also not-significantly higher (p.val=0.08) by 4 points in the presence of humates than in its absence.

### CONCLUSION

The results have shown that the solubilities Ca and P are affected in the feed of the test by the presence of MCP provided with humates. These results show that the solubilities of Ca and P are significantly better in the presence of humates (+3 and 4 points respectively). The solubility of Mg is systematically significantly better (from 1 to 4 points) in the presence of humates, whatever the digestion test.

### Example 4: In Vitro Study of the Mycotoxin Absorption Capacity of the Product of the Invention in the Digestive Tract of Monogastric Animals

The goal of this in vitro study is to evaluate the capacity of the product of the invention to absorb mycotoxins under the digestion conditions of monogastric animals. The principle consists in placing the product in contact with a given dose of mycotoxins at a given temperature and pH.

### Experimental Protocol

Four mycotoxins were chosen according to the recurrence of their presence in the feeds or plant raw materials intended for monogastric animals, but also according to the sensitivity of poultry and pigs (young and adults) towards these. The dose of each of the four mycotoxins was determined according to the European regulations (aflatoxin B1) and the sensitivity of the two species (zearalenone, ochratoxin A and deoxynivalenol). Thus, three doses (0.5%, 0.8% and 1.0%) of the product of the invention MCPH15 were placed in contact with 100 to 900 ng/ml of mixed mycotoxins (Table 4).

TABLE 4
Doses of mycotoxins and product of the invention introduced
into the monogastric digestion digestion system in vitro

| | Dose of mycotoxin | Dose of product of the |
|---|---|---|
| Mycotoxin | (ng/ml) | invention (g/100 g) |
| aflatoxin B1 | 20 | 0.5 |
| zearalenone | 250 | 0.8 |
| ochratoxin A | 100 | 1.0 |
| deoxynivalenol | 900 | |

The concentration of mycotoxins was measured after each incubation time in order to determine the quantity absorbed by the product.

The concentrations of mycotoxins were measured by UHPLC-MS/MS. More precisely, a 0.1 M buffered phosphate solution was prepared at pH 2.50±0.05 (average pH_{stomach} between the pigs and poultry) and enriched with mycotoxins to the concentrations given above. The sample was added to the solutions enriched with mycotoxins and the suspension was then incubated at 40° C. for 1 hour. The suspension was then centrifuged and the supernatant was sampled. The remaining supernatant was rejected, and the test material was then placed in suspension in a buffered 0.1 M solution of phosphate at pH 6.80±0.05 (average PHᵢₙₜₑₛₜᵢₙₑ between pigs and poultry) before being incubated at 40° C. for an additional 3 hours. The suspension was centrifuged again and the supernatant was sampled. The sample solutions were enriched with isotopically labelled internal standards before being analysed by UHPLC-MS/MS. The quantification was performed using external calibration solutions enriched with isotopically labelled internal standards. All the samples were prepared in quintuplicate.

The absorption rate is calculated as follows:

Absorption rate stomach (%)=([mycotoxin]−[mycotoxin]_{stomach supernatant})/[mycotoxin]ᵢₙᵢₜᵢₐₗ;

Final absorption rate (%)=1−(([mycotoxin]_{stomach supernatant}+[mycotoxin]_{intestine supernatant})/[mycotoxin]ᵢₙᵢₜᵢₐₗ).

### Results

The results show that the higher the product dose in the system, the higher the rate of absorption. The absorption rates at low pH (stomach level) are likewise higher than at high pH (intestine level). Passing into the intestine, the rise in pH results in a certain desorption of mycotoxins. More precisely, the absorption capacity is, in decreasing order: aflatoxin>zearalenone>ochratoxin>deoxynivalenol. Once in the intestine, the desorption rate (quantity of mycotoxins released into the system because not retained by the binder) is respectively 20, 37, 50 and 100% for deoxynivalenol, aflatoxin, zearalenone and ochratoxin. The product does not have any absorption capacity in the intestine for the latter (FIGS. 9 and 10).

### Example 5−Test 1 In Vivo on Meat Poultry: Effect of the Product of the Invention on Performance, Metabolism and Meat Quality

### Study Conditions

Zootechnical test on 48 cages of 40 male chickens inside a conventional rearing building having a standard consumption index (CI D35=1.50).

### Feed

Distribution of six feeds (i.e. 8 repetitions per feed) to meat chickens of the strain Ross 308 during 35 days of rearing.
The feed was manufactured so as to incorporate the tested products during mixing of the raw materials.
The feed does not contain microbial phytase and the raw materials chosen are low in endogenous phytases.
Products tested: monocalcium phosphates provided or not provided with humates. The doses of humates in the product of the invention vary from 1.0 to 2.5%.

### Measurements

The following measurements were performed during rearing:
Collective weight at D0, D7, D13, D21 and D28 (total weight of the animals/number of individuals) and individual weight at D35;
ADG (average daily gain) at D7, D13, D21, D28 and D35 (average weight/number of days in the period);
Feed consumption at D7, D13, D21, D28 and D35 (weight of leftover feed at each age, each bag of feed was weighed and identified upstream);
CI (consumption index) at D7, D13, D21, D28 and D35 (ADG/weight of feed consumed for each period);
Dose of blood minerals at D35
Dose of minerals in the tibia at D35
Quality of tibias:
   Latency-to-lie test at D27
   Post-mortem bone force and strength
Post-mortem meat quality
   The conditions of the study are summarised in Table 5 below.

TABLE 5
Test conditions on meat chickens in vivo

| Rearing | |
|---|---|
| characteristics | Standard consumption index (CI) |
| Feed phases | 3 phases: Start-up (D0-D13), Growth |
| | (D13-D28) and Finishing (D28-D35) |
| Feed | Recommendations Ross: 95% metabolisable energy, |
| characteristics | proteins and lipids |
| | Intake of P in the form of monocalcium phosphate |
| | (MCP) |
| | Start-up: 100% of digestible P in the six feeds |
| | Growth and finishing: |
| | 100% of digestible P with MCP in feed positive |
| | control |
| | 80% of digestible P with MCP in feed negative |
| | control |
| | Replacement of MCP by the product of the |
| | invention at a level of 80% digestible P |
| | in the last four feeds. |
| | Products tested: products of the invention |
| | containing 1.0 to 2.5% humates. |
| Zootechnical | Weight, Average Daily Gain, Feed consumption, CI |
| measurements | Litter quality |
| Individual | Weight at D35 |
| measurements | |
| Metabolism | Blood doses D35 |
| measurements | |
| Bone measurements | Doses of minerals in the tibias at D35 |
| | Latency-to-lie test at D27 |
| | Post-mortem bone strength measurements |
| Meat quality | Weight of carcass and meat pieces |
| | Evaluation of wooden breast and white stripping |
| | pH of the meat |
| Number of animals | 8 repetitions of 40 males |

### Results of the Study In Vivo

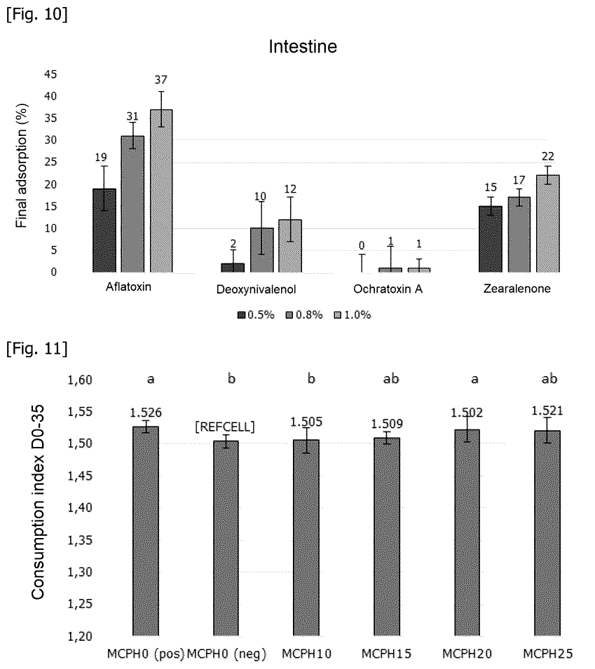

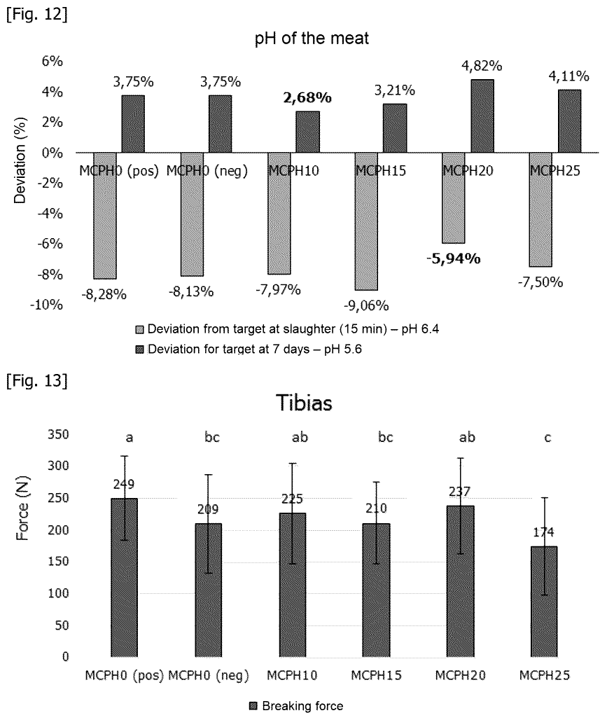

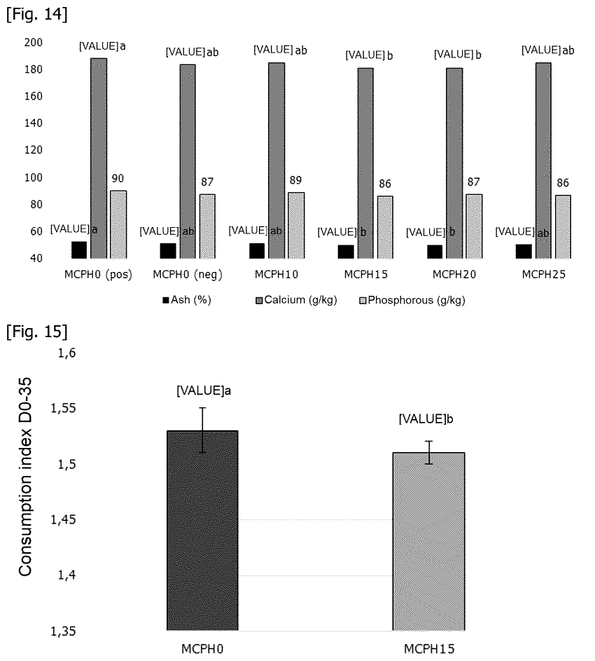

The results have shown the effects on the consumption index [FIG. 11], quality [FIG. 12] and bone strength [FIG. 13] and pH of the meat [FIG. 14].

At a lower dose of digestible P in the feed, the CI is better by −2 points (−1%) with MCPH10 and MCPH15 compared with the positive control (p.val=0.05) [FIG. 11]. Similarly, the pH of the meat is closest to the objective at the end of 15 minutes maturation (pH=6.4) with the intake of MCPH20 (p.val=0.02) whereas at 7 days storage (pH=5.6) this is the case with the intake of MCPH10 (p.val=0.13) [FIG. 14].

At an equal dose of digestible P in the feed, the breaking force of the tibias is 10% higher and 12% higher respectively with MCPH10 and MCPH20 compared with the negative control (p.val=0.004) [FIG. 13]. In addition, the ash content and the quantities of Ca and P in these same tibias are higher by 0.4 (p.val=0.001), 0.8 (p.val=0.004) and 1.7% (p.val=0.04) respectively with the intake of MCPH10 compared to the negative control [FIG. 14]. Thus, at equal quantity of nutrients, 80% of digestible P in the ration taken in with the help of the product of the invention makes it possible to obtain a better CI than with 100% digestible P intake with a standard monocalcium phosphate. Similarly, at an equal quantity of nutrients including digestible P, the product of the invention makes it possible to obtain better results for bone quality and meat preservation.

### Example 6−Meat Poultry Test In Vivo: Effect of the Product of the Invention on Performance, Leg Quality and Litter

### Study Conditions

Zootechnical test on 16 cages of 30 male chickens within a conventional rearing building having a prevalence of at least 70% pododermatitis and a standard consumption index (CI=1.50 to D35 and 1.65 to D42).

### Feed

Distribution of two feeds (i.e 8 repetitions per feed) to meat chickens of the strain Ross 308 during 42 days of rearing. The feed was manufactured so as to incorporate the tested products during mixing of the raw materials. At the end of production, a phytase is added on-top in the feeds at an equivalent dose of 500 FTU/kg. Products tested: monocalcium phosphates provided or not provided with humates (Control feed: MCPH0; Test feed: MCPH15).

### Measurements

The following measurements were performed during rearing:
Collective weight at D0, D7, D13, D21, D28 and D35 (total weight of the animals/number of individuals) and individual weight at D42;
ADG (average daily gain) at D7, D13, D21, D28, D35 and D42 (average weight/number of days in the period);
Feed consumption at D7, D13, D21, D28, D35 and D42 (weight of leftover feed at each age, each bag of feed was weighed and identified upstream);
CI (consumption index) at D7, D13, D21, D28, D35 and D42 (ADG/weight of feed consumed for each period);
Litter quality at D7, D13, D21, D28, D35 and D42 (litter score according to the grid of the ITAVI (French poultry technical institute));
Pododermatitis at D21 and D42 (score according to the ITAVI score grid);
Residual potassium in the litter at D21 and D42 (2 samples per cage, one sample at mid-distance between the edge of the cage on the sleeping side and the pipette line and at one third of the way between the feeder and the edge of the cage; one sample at mid-distance between the edge of the cage on the sleeping side and the pipette line and two thirds of the way between the feeder and the edge of the cage) by assay of potassium, using an inductively coupled plasma atomic emission spectrometer (ICP-AES), after mineralisation in hot aqua regia.

The conditions of the study are summarised in Table 6 below.

TABLE 6
Test conditions on meat chickens in vivo

| Rearing | 70% prevalence of pododermatitis |
|---|---|
| characteristics | Standard consumption index (CI) |
| Feed phases | 3 phases: Start-up (D0-D13), Growth |
| | (D13-D28) and Finishing (D28-D42) |
| Feed | Recommendations Ross: 6% metabolisable |
| characteristics | energy, 10% raw proteins, 10% digestible |
| | lysine, 6% calcium, 10% phosphorus, 11% Ca/P |
| | ratio relative to needs |
| | Intake of P in the form of monocalcium |
| | phosphate (MCP) |
| | Standard dose (500 FTU/kg) of phytase on-top. |
| | Start-up: 100% digestible P, in the two feeds |
| | Growth and finishing: Replacement of the MCP |
| | by the product of the invention at a level of |
| | 80% digestible P (22.7% P, 17.0% Ca and 0.0% Na) |
| | in one of the two feeds. |
| | Products tested: MCPH0 and MCPH15 |
| Zootechnical | Weight, Average Daily Gain, Feed consumption, CI |
| measurements | Litter quality |
| Individual | Weight at D42 and pododermatitis measurements |
| measurements | |
| Litter measurements | Humidity |
| | Phosphorus |
| Number of animals | 8 repetitions of 30 males |

### Results of the Study In Vivo

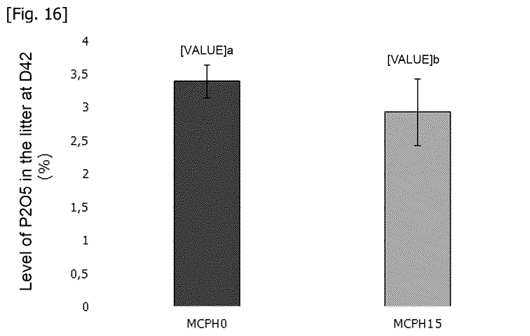

Among the results obtained, significant effects were observed on the consumption index (CI) over the period 0-35 days, as illustrated in FIG. 15.
This shows that the CI is significantly lower by 2 points (−1%; p.val=0.056) over the period 0-35 days with the product of the invention (MCPH15), compared with the control MCPH0. This result confirms that which was already observed in the previously presented test. Moreover, at an equal dose of digestible phosphorous in the feed, the product of the invention can significantly reduce (p.val=0.001) by 14% the quantity of P₂O₅ in the litter at D42 relative to the intake of a standard monocalcium phosphate (FIG. 16).

1. A dietary raw material for animal nutrition, comprising an organo-mineral complex containing a dietary phosphate and a humic substance, said humic substance forming physicochemical bonds with phosphorus atoms.

2. The raw material according to claim 1, characterised in that the dietary phosphate is chosen from calcium phosphate, magnesium phosphate, monosodium phosphate, calcium-sodium phosphate and mixtures thereof.

3. The raw material according to claim 1, characterised in that the dietary phosphate is chosen from monocalcium phosphate, dicalcium phosphate, monodicalcium phosphate, tricalcium phosphate, and mixtures thereof.

4. The raw material according to claim 1, characterised in that the dietary phosphate is in the form of tri-magnesium phosphate.

5. The raw material according to claim 1, characterised in that the humic substance is a potassium humate or a sodium humate.

6. A method for manufacturing the dietary raw material according to claim 1, comprising a step of preparing a dispersion or aqueous solution containing the humic substance, followed by mixing this dispersion or this solution with a source of phosphorus and with a source of calcium, magnesium or sodium.

7. The manufacturing method according to claim 6, characterised in that the source of phosphorus is phosphoric acid.

8. The manufacturing method according to claim 6, characterised in that the source of calcium is calcium carbonate, quicklime or slaked lime.

9. The manufacturing method according to claim 6, characterised in that the humic substance is extracted from leonardite.

10. The manufacturing method according to claim 6, characterised in that the mixing of the aqueous dispersion or aqueous solution containing the humic substance, with the source of phosphorus and with the source of calcium, magnesium or sodium, is carried out at a temperature ranging from 50° C. to 80° C.

11. A method for improving the bioavailability of mineral phosphorus in a monogastric livestock animal, comprising utilizing the dietary raw material according to claim 1.

12. A method for the nutrition of a livestock animal comprising a step of incorporating the dietary raw material according to claim 1 in the ration of the animal.

13. The raw material intended for animal feed obtainable by preparing an aqueous solution comprising a water-soluble humic substance, a water-soluble source of mineral phosphorus, and optionally a water-soluble source of mineral calcium.
